(19) United States
(12) Patent Application Publication
(10) Pub. No.: US 2011/0315020 A1
(43) Pub. Date: Dec. 29, 2011

(54) Automated Coffee Machine Including a Position Detection Device and/or Positioning Speed Detection Device

(75) Inventors: Holger Stürcken, Erlen (CH); Thinh-Khin Tong, Goldach (CH)

(73) Assignee: Eugster/Frismag AG, Amriswil (CH)

(21) Appl. No.: 13/171,234

(22) Filed: Jun. 28, 2011

(30) Foreign Application Priority Data
Jun. 29, 2010 (DE) 102010025530.0

(51) Int. Cl. A47J 31/40

(52) U.S. Cl. 99/280

(57) ABSTRACT

An automated coffee machine including a position detection device and/or positioning speed detection device on a positionable or adjustable unit of the automated coffee machine, wherein a ferromagnetic tooth wheel is pivoted with a drive line of the positionable or adjustable unit. The position detection device and/or positioning control device comprises a Hall sensor/magnet unit which is disposed vis-a-vis of a toothing of the ferromagnetic tooth wheel.

### BACKGROUND OF THE INVENTION

1. Field of the Invention

The present invention relates to an automated coffee machine including a position detection device and/or positioning speed detection device on a positionable or adjustable unit of the automated coffee machine, particularly a brewing unit and/or a part of the brewing unit.

2. Description of the Related Art

In a prior art espresso machine having a force-controlled reciprocating piston and a carriage with an exhauster movable above an opening of the brewing chamber and sealing the opening of the brewing chamber in one operating position by means of a piston-like section on the underside of the carriage, a brewing chamber cartridge forming the circumferential wall of the brewing chamber may be moved, force-controlled, in one operation position of the carriage, into a compressing position and returned after a brewing process (DE 20 2004 018 776 U1). A reciprocating piston of the brewing chamber is connected, via a spindle cylinder, with an electromotive reciprocating piston drive comprising a motor and a respective gear. The carriage with the piston-like section may be moved by a further electromotive drive also comprising a motor and a coupled gear. The gear of the carriage drive is connected with a lock disc and two cam discs which control the positions of the carriage and, partly, the movements of the reciprocating piston via associated contacts. In this way, the positions of the spindle cylinder, of the reciprocating piston connected with it and via it, indirectly, that of the brewing chamber cartridge when pressed to the reciprocating piston, will be detected, namely by a foot contact and a head contact operated by an actuation arm on the spindle cylinder and arranged in a circuit of the motor of the reciprocating piston drive. For the exact adjustment of the reciprocating piston, the foot contact and the head contact should be fine-adjusted.

The same applies also for an additional brewing chamber cartridge position contact by which the position of the brewing chamber cartridge in the sealing position on the carriage may be signaled for safety, to allow a brewing process.

The above referred-to head contact, the foot contact and the brewing chamber cartridge position contact may be realized by a micro switch.

Furthermore, the spindle cylinder of this prior art espresso machine may be provided, on the reciprocating piston thereof, with a sensor with an encoder in order to measure the adjustment rate (positioning rate) of the spindle cylinder and to determine therefrom a stop position of the reciprocating piston when the coffee grounds filled into the brewing chamber is pre-compressed prior to the brewing process at a defined measure independently from the amount of coffee. To this end, the sensor with the encoder measures the upward motion of the reciprocating piston by determining the rotational speed of the spindle cylinder. When reaching a determined reduction of speed caused by the load of the motor in case of coffee grounds compression, the encoder switches the motor off. If, however, as is common in practice, the sensor has been designed for determining the motor current and the upward motion of the reciprocating piston is deducted from it, the rotational speed of the DC motor is, in principle, reciprocal to the current consumption, inaccuracies of such indirect determination of the rotational speed and hence of the determination of the filling height are to be expected.

### BRIEF SUMMARY OF THE INVENTION

The present invention is based on the problem, while avoiding the disadvantages of the position detection devices or positioning speed detection devices common in prior fully art automated coffee machines, to employ devices which do not require elaborate adjustment or are not subject to tolerances of mechanical components, are easy to mount and, having not movable contacts, are not subject to wear, are reliable and exact, are substantially unaffected particularly by temperature changes and promise a long life.

This problem is solved in an automated coffee machine including a position detection device and/or positioning speed detection device on a positionable or adjustable unit of the automated coffee machine, particularly a brewing unit and/or a part of the brewing unit. In this coffee machine, a ferromagnetic tooth wheel is pivotally connected with a drive line of the positionable or adjustable unit. The position detection device and/or the positioning speed detection device comprises a Hall sensor/magnet unit which is disposed vis-a-vis of a toothing of a ferromagnetic tooth wheel.

By the Hall sensor of the preferably stationary Hall sensor/magnet unit, a Hall voltage is generated which ideally is proportional to the magnetic flow density in the Hall sensor, wherein the magnetic flow density depends on the position of the toothing of the ferromagnetic tooth wheel disposed vis-a-vis of the Hall sensor. The magnetic flow is generated by the magnet of the Hall sensor/magnet unit and runs, for a major part, via the toothing, the position of which vis-a-vis of the Hall sensor of the Hall sensor/magnet unit has an impact on the magnetic flow density in the Hall sensor. The periodic Hall voltage being an analog signal of the rotational position of the ferromagnetic tooth wheel or of its rotational speed which is generated according to the rotation of the ferromagnetic tooth wheel can be processed and then counted by a counter, or can be digitalized by an analog-digital processor wherefrom, by data processing means, the position of the tooth wheel, or its rotational speed can simply be further evaluated in form of digital data, for instance can be compared with a predetermined nominal position, and can be used for controlling the motor in the drive line of the position controlled or adjustable unit of the automated coffee machine and/or can be displayed for a user of the automated coffee machine.

### BRIEF DESCRIPTION OF THE SEVERAL VIEWS OF THE DRAWINGS

In the following, an embodiment of the present invention will be explained based on a drawing with two figures from which further advantages of the use of the invention may be taken.

FIG. 1 is a Hall sensor/magnet unit vis-a-vis a ferromagnetic tooth wheel coupled with a gear of an automated coffee machine, as seen from above; and

FIG. 2 is the Hall sensor/magnet unit showing a section of the gear, substantially in a slightly enlarged side view.

### DETAILED DESCRIPTION OF THE INVENTION

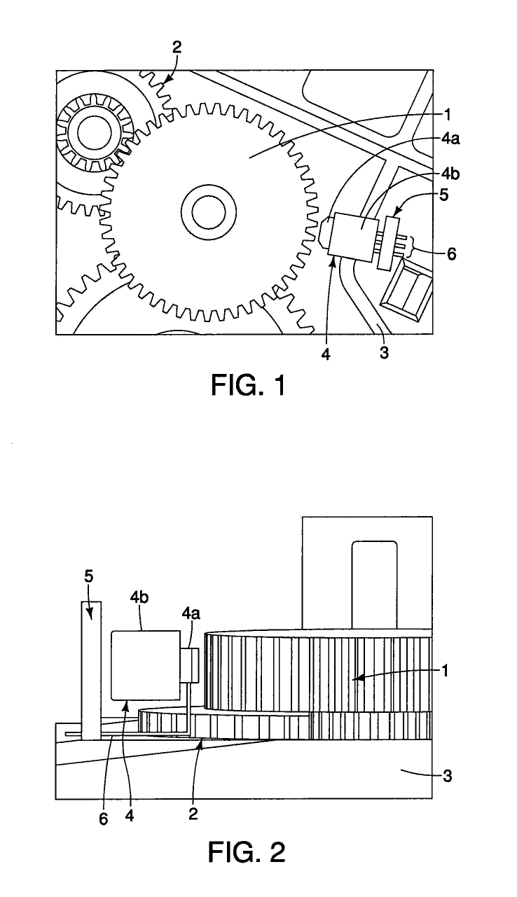

In FIGS. 1 and 2 a ferromagnetic tooth wheel 1 is shown having a straight radial serration consisting of an iron-containing alloy and constituting a component of a gear generally referred to as 2. The gear 2 is driven by a DC motor not shown. The components of gear 2 including the ferromagnetic tooth wheel 1 are pivotally supported on a mounting plate 3 of the (fully) automated coffee machine. A DC motor driving gear 2 is not shown.

Radially vis-a-vis of the toothing of the ferromagnetic tooth wheel 1 and at the same level relative to the toothing, a Hall sensor/magnet unit 4 is provided on the mounting plate 3, namely by means of a printed circuit board 5 mounted on the mounting plate 3 and contacted with contacts 6. The contacts 6 lead to an electronic control device, not shown, to a counter, or to an analog-digital converter.

As can be taken in detail from FIGS. 1 and 2, the Hall sensor 4a of the Hall sensor/magnet unit 4 is arranged between a permanent magnet 4b and the toothing of the ferromagnetic tooth wheel 1, wherein the Hall sensor 4a is disposed vis-a-vis of the axial center of the toothing.

The tooth pitch of the ferromagnetic tooth wheel 1 is of such a size that the front face of the Hall sensor 4a facing the toothing, substantially faces either one tooth or one tooth space from which a large flow density change depending on the angle of rotation of the ferromagnetic tooth wheel 1 will result.

The drawing does not show in detail the complete drive-technological connection of drive 2 on a positionable brewing chamber or on a brewing piston in the brewing chamber.

In the present invention, the Hall sensor/magnet unit vis-a-vis of the toothing of the ferromagnetic tooth wheel may advantageously be used in an automated coffee machine for positioning a brewing unit comprising a drive with a DC motor and a gear, wherein prior to a brewing process, the brewing unit is moved for initialization to its two end stops. The distance between the two end stops may be monitored by means of the Hall sensor/magnet unit vis-a-vis of the toothing of the ferromagnetic tooth wheel coupled to the gear. Subsequently, the brewing unit can be moved, starting from the last-encountered end stop, into its operation position, while it is monitored by the Hall sensor/magnet unit, and can reach from there further controlled positions without any further initializations, which is monitored by the Hall sensor/magnet unit as well.

A further favorable use of the Hall sensor/magnet unit in the automated coffee machine serves for the determination of the filling height of the ground coffee in the brewing unit by monitoring the path of the piston in the brewing unit between one grinding position in which the brewing chamber receives ground coffee and the brewing position of the piston in which the ground coffee is compressed by a constant pressure prior to each brewing process. To this end, the path between the grinding position and the brewing position is evaluated by means of data processing means disposed after the Hall sensor.

The filling height might also be found in that the speed, or the speed drop of the electro motor in the drive line of the piston and hence of the ferromagnetic tooth wheel pivoted with a gear in the drive line is detected and evaluated. The speed may be found by the data processing means disposed after the Hall sensor, particularly by a counter simply by counting the Hall voltage fluctuations during the course of a given constant time interval.

The Hall sensor of the Hall sensor/magnet unit in the automated coffee machine is effectively penetrated by the magnetic flow sourcing from the magnet of the Hall sensor/magnet unit in that the Hall sensor/magnet unit is disposed vis-a-vis of the toothing of the ferromagnetic tooth wheel so that the Hall sensor is disposed between the magnet the toothing. Moreover, such a Hall sensor magnet unit is compact.

Further, it is suitable to dispose the Hall sensor/magnet unit radially vis-a-vis of a straight radial serration of the ferromagnetic tooth wheel. Such straight radial serration of the ferromagnetic tooth wheel can easily be realized and has the advantage that axial position changes of the ferromagnetic tooth wheel vis-a-vis of the hall sensor/magnet unit have no impact on the Hall voltage.

Further, the Hall sensor/magnet unit is suitably contacted with a stationary printed circuit board in the automated coffee machine. The printed circuit board may be connected with contacts for connecting a control electronic, device, a counter or data processing means. In this connection, the simple mounting of the Hall sensor/magnet unit to the printed circuit board and the small wiring elaboration are advantageous.

Further, the ferromagnetic tooth wheel facing the Hall sensor/drive unit, may be a constituent of a gear in the drive line of the automated coffee machine. In this way, the ferromagnetic tooth wheel is compactly mounted and the desired rotation angle-dependent influence of the Hall sensor/magnet unit can, depending on the transmission ratio, be dimensioned in accordance with the rotation of a motor shaft of the drive.

In a substantial application alternative, the Hall sensor/magnet unit in a drive line of the automated coffee machine may be arranged, in terms of driving, between a DC motor and the positionable brewing unit, or may be arranged between the DC motor and a piston adjustable in the brewing unit.

1. An automated coffee machine including a position detection device and/or positioning speed detection device on a positionable or adjustable unit of the automated coffee machine, particularly a brewing unit and/or a part of the brewing unit, wherein:
a ferromagnetic tooth wheel is pivotally connected with a drive line of the positionable or adjustable unit, and
the position detection device and/or the positioning speed detection device comprises a Hall sensor/magnet unit disposed vis-a-vis of a toothing of a ferromagnetic tooth wheel.

2. The automated coffee machine according to claim 1, wherein:
the Hall sensor/magnet unit is arranged vis-a-vis of the toothing of the ferromagnetic tooth wheel so that the Hall sensor is disposed between the magnet and the toothing.

3. The automated coffee machine according to claim 2, wherein:
the Hall sensor/magnet unit is arranged radially vis-a-vis of a straight radial serration of the ferromagnetic tooth wheel.

4. The automated coffee machine according to claim 1, wherein:
the Hall sensor/magnet unit is contacted with a stationary printed circuit board in the automated coffee machine.

5. The automated coffee machine according to claim 1, wherein:
the ferromagnetic tooth wheel constitutes a component part of a gear in the drive line.

6. The automated coffee machine according to claim 1, wherein:
the drive line is, in driving terms, disposed between a DC motor and the positionable brewing unit.

7. The automated coffee machine according to claim 1, wherein:
the drive line is, in driving terms, disposed between a DC motor and a piston adjustable in the brewing unit.
